(19) United States
(12) Patent Application Publication
(10) Pub. No.: US 2026/0154428 A1
(43) Pub. Date: Jun. 4, 2026

(54) APPARATUS AND METHOD FOR MODULATING COMMUNICATION SIGNALS FOR WIRELESS COVERT CHANNEL

(71) Applicant: ELECTRONICS AND TELECOMMUNICATIONS RESEARCH INSTITUTE, Daejeon (KR)

(72) Inventors: Yong-Sung JEON, Daejeon (KR); Sang-Woo LEE, Daejeon (KR); Dong-Ho KANG, Daejeon (KR); Jeong-Nyeo KIM, Daejeon (KR)

(21) Appl. No.: 19/227,917

(22) Filed: Jun. 4, 2025

(30) Foreign Application Priority Data
Dec. 2, 2024 (KR) 10-2024-0176697

(51) Int. Cl. G06F 21/60; H04L 1/00

(52) U.S. Cl. CPC G06F 21/606; H04L 1/0009

(57) ABSTRACT

Disclosed herein are an apparatus and method for modulating communication signals for a wireless covert channel. The apparatus for modulating communication signals for a wireless covert channel is configured to modulate a communication signal such that a bit value ‘1’ and a bit value ‘0’ are defined according to a time gap between signals by generating a covert channel signal in which the time gap between the signals is differently set in the communication signal, and transmit the communication signal modulated by generating the covert channel signal.

### CROSS REFERENCE TO RELATED APPLICATION

This application claims the benefit of Korean Patent Application No. 10-2024-0176697, filed Dec. 2, 2024, which is hereby incorporated by reference in its entirety into this application.

### BACKGROUND OF THE INVENTION

### 1. Technical Field

The present disclosure relates generally to communication signal modulation technology, and more particularly to technology for modulating communication signals for a wireless covert channel.

### 2. Description of the Related Art

When information is transferred as a signal using wireless communication, it is transmitted with the information converted into a frequency or pulse suitable for transmission, and this process is called modulation. A representative modulation method includes amplitude modulation, frequency modulation, phase modulation, and the like.

In modern times, digital modulation methods that directly modulate digital data onto a carrier wave and transmit the carrier wave are widely used. Representative examples thereof include Amplitude Shift Keying (ASK), Frequency Shift Keying (FSK), and Phase Shift Keying (PSK), etc.

The representative reason for performing modulation is to select the frequency suitable for transmission. That is, when the original signal is transmitted directly through the antenna, the frequency of the signal is too low, and thus the signal cannot be propagated over a long distance. Further, because the original signal has low frequency to have a long wavelength, the size of the antenna is excessively increased. As a result, the original signal is converted into a high-frequency signal having a short wavelength using modulation, and thus the size of the antenna is decreased. In this way, existing modulation is basically intended to transmit signals over long distance using an antenna.

Furthermore, as a method for transferring information, there is line coding. This is a method that converts unmodulated digital data into the form of pulse signals optimized for transmission environments, and is primarily used in digital wired communication. Representative methods of line coding include Non Return to Zero (NRZ), Return to Zero (ZR), Manchester, and the like.

Meanwhile, in conventional covert (or steganographic) channel technologies, a digital modulation method or a line coding method commonly used in normal communication is still employed in spite of the unique environment of a covert channel. There are existing signal transmission methods that utilize five media for wireless covert channel communication, that is, sound, light, heat, magnetic fields, and electromagnetic waves.

In conventional covert channel technologies, modulation methods used in covert channel communication employs a digital modulation method or line coding used in normal communication.

The transmission method in normal communication assumes that there are sufficient resources and environments required for signal transmission. That is, in the case of digital modulation, signals may be transmitted over long distances using an antenna, whereas line coding is mainly used in wired communication and is not subject to distance limitations.

However, the covert channel inevitably has limitations in a transmission range because wireless signals need to be generated in the state in which an antenna is not used and to be transferred to a receiving device. Also, since the purpose of signals generated for the covert channel is to remain undetected by devices other than a designated receiver, it is critically important to minimize signal generation time. For example, when signals in the covert channel are consecutively generated (e.g., in the case where signals are continuously generated to transmit a value in which ‘1’ consecutively appears using ASK modulation), the detection of the signals becomes easy to decrease concealment. Also, consecutively generating signals for a long period may lead to system overload, thereby causing damage to the system device.

Meanwhile, Korean Patent No. 10-2227317 entitled “Wi-Fi PHY Layer multi-band Covert Channel Detector” discloses a Wi-Fi covert channel detector that can simultaneously perform covert channel monitoring by simultaneously receiving Wi-Fi signals through multiple channels and then separating the received Wi-Fi signals into logical multi-channel signals.

### SUMMARY OF THE INVENTION

Accordingly, the present disclosure has been made keeping in mind the above problems occurring in the prior art, and an object of the present disclosure is to maximize concealment by which a covert channel cannot be easily detected and to minimize a system load caused by the generation of signals for the covert channel by minimizing the generation time of signals for the covert channel.

Another object of the present disclosure is to effectively perform communication even in a system that is highly constrained from the aspect of a covert channel.

A further object of the present disclosure is to perform covert channel communication using only a signal having a minimum generation time, thus making it more difficult for a third party other than an intended receiver to detect signals in the covert channel.

In accordance with an aspect of the present disclosure to accomplish the above objects, there is provided an apparatus for modulating communication signals for a wireless covert channel, including one or more processors, and memory configured to store at least one program that is executed by the one or more processors, wherein the at least one program is configured to modulate a communication signal such that a bit value ‘1’ and a bit value ‘0’ are defined according to a time gap between signals by generating a covert channel signal in which the time gap between the signals is differently set in the communication signal, and transmit the communication signal modulated by generating the covert channel signal.

The at least one program may be configured to, when the time gap between the signals is longer than a preset time gap, define the bit value as the bit value ‘1’ or ‘0’, whereas when the time gap is shorter than the preset time gap, define the bit value as the bit value ‘0’ or ‘1’.

The at least one program may be configured to define the bit value differently for each time gap in which the covert channel signal is generated by generating the covert channel signal whenever the bit value changes in the communication signal.

The at least one program may be configured to define the bit value such that a number of identical bit values, equal in number to an integer value obtained by dividing the entire time gap by a preset time, are present during the time gap.

The at least one program may be configured to define the bit value such that only one bit value ‘1’ or ‘0’ is present between the signals, after which a bit value ‘0’ or ‘1’ is not present or, alternatively, at least one bit value ‘0’ or ‘1’ is present.

The at least one program may be configured to define the bit value such that only one bit value ‘1’ or ‘0’ is present during a preset first time between the signals and a number of bit values ‘0’ or ‘1’ equal in number to an integer value obtained by dividing a remaining time, which is obtained by subtracting the preset first time from the entire time gap, by a preset second time, are present between the signals.

In accordance with another aspect of the present disclosure to accomplish the above objects, there is provided a method for modulating communication signals for a wireless covert channel, the method being performed by an apparatus for modulating communication signals for a wireless covert channel, the method including modulating a communication signal such that a bit value ‘1’ and a bit value ‘0’ are defined according to a time gap between signals by generating a covert channel signal in which the time gap between the signals is differently set in the communication signal, and transmitting the communication signal modulated by generating the covert channel signal.

The modulating may include, when the time gap between the signals is longer than a preset time gap, defining the bit value as the bit value ‘1’ or ‘0’, whereas when the time gap is shorter than the preset time gap, defining the bit value as the bit value ‘0’ or ‘1’.

The modulating may include defining the bit value differently for each time gap in which the covert channel signal is generated by generating the covert channel signal whenever the bit value changes in the communication signal.

The modulating may further include defining the bit value such that a number of identical bit values, equal in number to an integer value obtained by dividing the entire time gap by a preset time, are present during the time gap.

The modulating may include defining the bit value such that only one bit value ‘1’ or ‘0’ is present between the signals, after which a bit value ‘0’ or ‘1’ is not present or, alternatively, at least one bit value ‘0’ or ‘1’ is present.

The modulating may further include defining the bit value such that only one bit value ‘1’ or ‘0’ is present during a preset first time between the signals and a number of bit values ‘0’ or ‘1’ equal in number to an integer value obtained by dividing a remaining time, which is obtained by subtracting the preset first time from the entire time gap, by a preset second time, are present between the signals.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a diagram illustrating a separated time-gap modulation method according to an embodiment of the present disclosure;

FIG. 2 is a diagram illustrating a continuous time-gap modulation method according to an embodiment of the present disclosure;

FIG. 3 is a diagram illustrating a variable time-gap modulation method according to an embodiment of the present disclosure;

FIGS. 4 and 5 are diagrams illustrating the case where it is difficult to control the generation time of covert channel signals according to an embodiment of the present disclosure;

FIG. 6 is a diagram illustrating a transmission packet structure according to an embodiment of the present disclosure;

FIG. 7 is a diagram illustrating an example of packet transmission using separated time-gap modulation according to an embodiment of the present disclosure;

FIG. 8 is a diagram illustrating an example of packet transmission using continuous time-gap modulation according to an embodiment of the present disclosure;

FIG. 9 is a diagram illustrating an example of packet transmission using variable time-gap modulation according to an embodiment of the present disclosure;

FIG. 10 is an operation flowchart illustrating a method for modulating communication signals for a wireless covert channel according to an embodiment of the present disclosure; and

FIG. 11 is a diagram illustrating a computer system according to an embodiment of the present disclosure.

### DESCRIPTION OF THE PREFERRED EMBODIMENTS

The present disclosure will be described in detail with reference to the attached drawings. Repeated descriptions and descriptions of known functions and configurations which have been deemed to make the gist of the present disclosure unnecessarily obscure will be omitted below. The embodiments of the present disclosure are provided to more fully describe the disclosure to those skilled in the art. Therefore, the shapes, sizes, etc. of elements in the drawings may be exaggerated to make the description clearer.

In the specification, when an element is referred to as “comprising” or “including” a component, it does not preclude another component but may further include other components unless the context clearly indicates otherwise.

The present disclosure may be variously modified and may have various embodiments, and the embodiments are intended to be illustrated and described in detail in the accompanying drawings.

However, this is not intended to limit the present disclosure to particular modes of practice, and it should be appreciated that all changes, equivalents, and substitutes that do not depart from the spirit and technical scope of the present disclosure are encompassed in the present disclosure.

In description of components of the embodiment of the present disclosure, terms such as first, second, A, B, (a), and (b) may be used. These terms are used merely to distinguish one component from other components, and the essentials, order, or sequence of the components are not limited by the terms.

Unless otherwise defined, all terms including technical and scientific terms used herein have the same meaning as commonly understood by one of ordinary skill in the art to which the present disclosure belongs. It will be further understood that terms used herein should be construed as having a meaning that is consistent with their meaning in the context of this specification and the relevant art and will not be interpreted in an idealized or overly formal sense unless expressly so defined herein.

It will be understood that when a component is referred to as being “associated” with another component, it can be directly associated with or connected to the other component or intervening components may be present therebetween.

The terms used in embodiments are used only to describe a specific embodiment, and are not intended to limit the present disclosure. A singular expression includes a plural expression unless a description to the contrary is specifically pointed out in context. It will be further understood that the terms “comprise”, “include”, “have”, etc. when used in this specification, specify the presence of stated features, numbers, steps, operations, elements, or combinations thereof but do not preclude the possibility of the presence or addition of one or more other features, numbers, steps, operations, elements, or combinations thereof.

Hereinafter, embodiments of the present disclosure will be described in detail with reference to the attached drawings. In description of the present disclosure, independent reference numerals are used to designate the same components in the drawings to facilitate overall understanding.

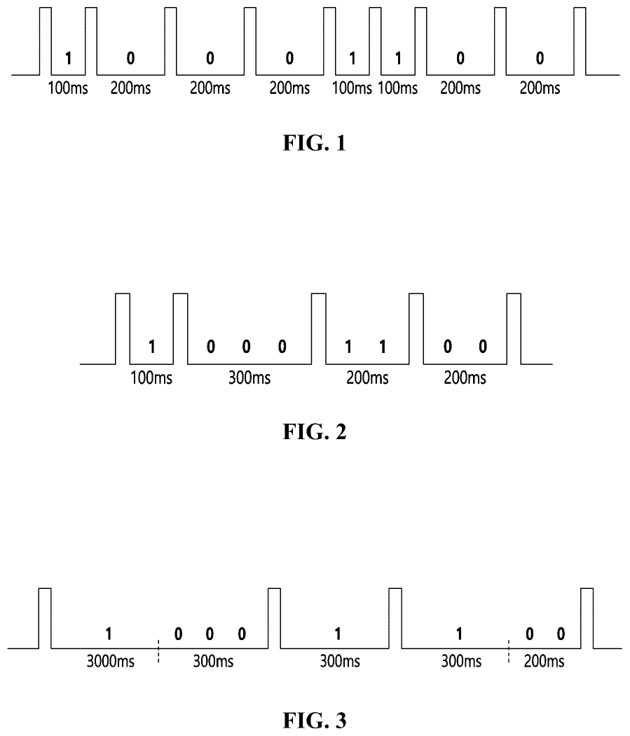

In order to achieve the above-described objects of the present disclosure, a method for modulating communication signals for a covert channel, as illustrated in FIGS. 1, 2, and 3 is presented. The significant characteristics of three modulation methods presented in the present disclosure are schemes in which signal generation time does not contain information and only a time gap between signals contains information. Therefore, the duration of the signal generation may be extremely short just enough to check whether the signal has been generated.

FIG. 1 is a diagram illustrating a separated time-gap modulation method according to an embodiment of the present disclosure. FIG. 2 is a diagram illustrating a continuous time-gap modulation method according to an embodiment of the present disclosure. FIG. 3 is a diagram illustrating a variable time-gap modulation method according to an embodiment of the present disclosure.

The present disclosure relates to an apparatus and method for modulating communication signals for a wireless covert channel (or wireless steganographic channel), in which only the designated transmitter and receiver can detect or identify transferred information and normal users are unable to easily recognize the information in a situation requiring extreme security or when the information desired to be transferred is highly important.

FIGS. 1 to 3 respectively illustrate modulation methods for generating a covert channel signal and transferring 8-bit information “10001100”. It can be seen that the duration of each wireless signal does not contain information, and a time gap, that is, an interval in which no signals are present between each wireless signal and a subsequent wireless signal, contains digital information. That is, the present disclosure may generate a covert channel signal in which a time gap between signals is differently set in a communication signal and then modulate the communication signal to include a bit value ‘1’ and a bit value ‘0’ according to the time gap between the signals.

Three modulation methods presented in the present disclosure will be described in detail below.

Referring to FIG. 1, this modulation method is a method that generates signals on a bit basis, and is referred to as a “Separated Time-Gap Modulation” method. This modulation method may generate a signal for each bit, and may vary the time gap between signals depending on the value of the bit. That is, the time gap between signals is differently defined to such an extent that the bit value ‘1’ and the bit value ‘0’ can be distinguished from each other. For example, in FIG. 1, communication may be performed by setting the time gap (interval) between signals to 100 msec for the bit value ‘1’ and by setting the time gap between signals to 200 msec for the bit value ‘0’. This is only an example, and the time gap may be adjusted as long as bit values can be distinguished from each other.

Referring to FIG. 2, this modulation method is a method that generates signals on the same bit value basis and is referred to as a “Continuous Time-Gap Modulation” method. This modulation method may further increase a time gap without generating signals in the case of the same bit value, and may generate a signal only when the bit value changes. For example, in FIG. 2, a time gap for one bit is defined as 100 msec (it may be defined as various time gaps depending on the characteristics of the system), and a time gap after an initial signal has been generated is defined as the bit value ‘1’ (in some cases, it may be defined as ‘0’). Based on this definition, a time gap of 100 msec is maintained for the bit value ‘1’ after the generation of the initial signal. Thereafter, the following bit value changes to ‘0’, and thus a second signal may be generated. Because three consecutive bit values of ‘0’ appear, a time gap is maintained at 300 msec, after which the bit value changes again to ‘1’, and thus a third signal may be generated. In this way, each signal may be newly generated only at time points at which the bit value changes. This is only an example, and the generation times of signals and the time gap between signals, corresponding to one bit, may be adjusted depending on the characteristics of the system or the communication environment of the covert channel. Such a “continuous time-gap modulation” method is advantageous in that the generation of signals may be reduced compared to the “separated time-gap modulation” method.

Referring to FIG. 3, this modulation method is a method that generates signals only for a specific bit value (i.e., a bit value is ‘1’ or ‘0’) and is referred to as a “Variable Time-Gap Modulation” method. This modulation method generates signals only for the specific bit value, and merely increases a time gap without generating signals for the remaining bit value. For example, in FIG. 3, signals are generated only when the bit value is ‘1’ (in some cases, signals may be generated only when the bit value is ‘0’). Also, in FIG. 3, a time gap of 300 msec is maintained for the bit value ‘1’, and a time gap for the following bit value ‘0’ is defined as 100 msec (this may be defined as various time gaps depending on the characteristics of the system). Based on this definition, a time gap of 300 msec is maintained for the bit value ‘1’ after the generation of the initial signal. Thereafter, even for the following bit values ‘000’, a time gap may be additionally maintained at 300 msec without generation of signals. Thereafter, because the bit value changes to ‘1’, a second signal may be generated, and then a time gap of 300 msec may be maintained. In this way, a signal may be newly generated only at a time point at which the bit value becomes ‘1’. This is only an example, and a bit value for which a signal is generated, the generation time of each signal, and the time gap between signals, corresponding to the bit value, may be adjusted depending on the characteristics of the system or the communication environment of the covert channel. Such a “variable time-gap modulation” method is a method performed by a system in which the time during which a covert channel signal can be generated is limited, that is, a system which cannot generate a covert channel signal at any time, and is suitable for a system which can generate a covert channel signal again only after a certain period of time has elapsed since a covert channel signal was generated once.

The reason why the above-described three modulation methods according to the present disclosure are useful in a covert channel communication environment is described in detail below. In other words, the reason for presenting the modulation methods, as in the case of the three modulation methods according to the present disclosure, which minimize the duration in which a signal is generated and maintained to such an extent that only generation or non-generation of a signal is checked, and which transmit information using only a time gap between signals is due to the unique characteristics of the covert channel.

That is, a covert signal generated for covert channel communication is neither a signal that uses a typical communication device (e.g., a communication modem, an antenna, or the like) nor a signal that is spontaneously generated from the system. The covert signal is one that is forcibly generated by consuming system resources from a component not originally intended for communication.

In the case of a covert channel using heat, a covert channel using a magnetic field, or a covert channel using electromagnetic waves, a representative covert signal generation method is to impose a heavy load on components related to computation, such as a Central Processing Unit (CPU) or memory.

When Amplitude Shift Keying (ASK), which is one of digital modulation methods used in normal communication, or Non-Return to Zero (NRZ), which is one of line coding methods, is used for covert channel communication (actually, ASK or NRZ is used for existing covert channel communication), a heavy load is continuously imposed on the system to result in system damage in case that a transmission value composed of consecutive ‘1’s is transmitted (e.g., transmitting 0xFF).

Therefore, in order to prevent an excessive load from being imposed on the system to generate covert channel signals, new modulation methods presented by the present disclosure are required.

In addition to the above-described need to minimize a system load, there may occur the cases where it is difficult to control the generation time of covert channel signals (e.g., generation start or end time) of covert signal generation, according to the type of covert channel signals (e.g., an electromagnetic wave, a magnetic field, heat or the like) or the type of device that generates the signals (e.g., CPU, memory, or the like). Two examples where it is difficult to control the generation time of covert channel signals are described as follows.

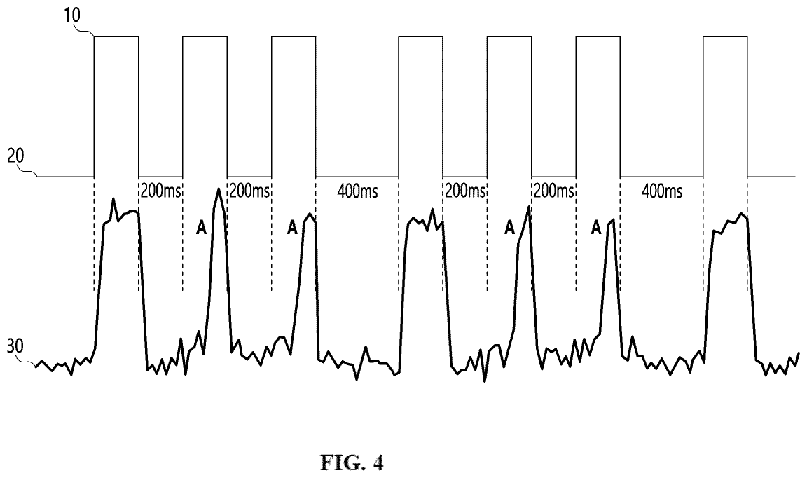

First, there is the case where the control of generation time of a covert channel signal is difficult when the covert channel signal is generated by imposing a heavy load on a CPU to generate a magnetic field, and this case is illustrated in FIG. 4.

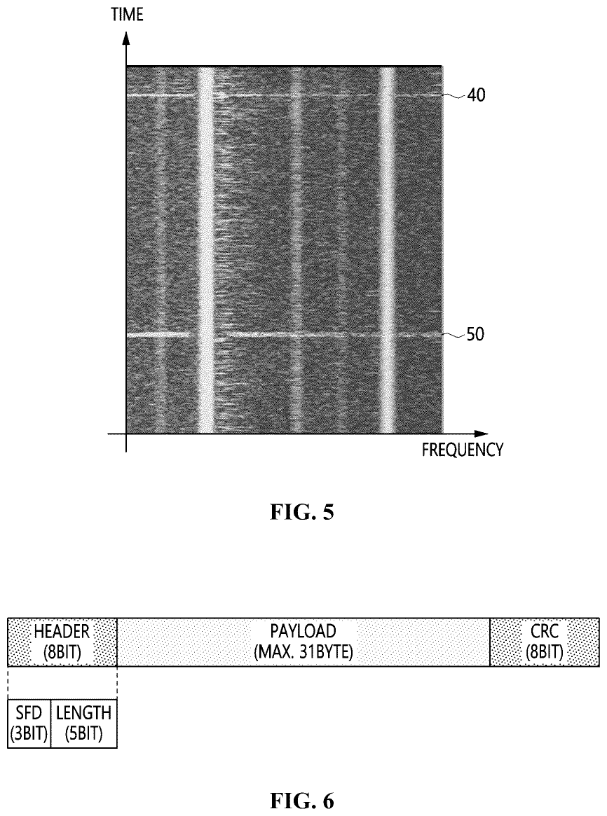

FIGS. 4 and 5 are diagrams illustrating the case where it is difficult to control the generation time of covert channel signals according to an embodiment of the present disclosure.

As illustrated in FIG. 4, a “covert channel generation code inactivation” interval 20 exists between “covert channel generation code activation” intervals 10, and the inactivation interval includes two time gaps of 200 msec and 400 msec. It can be seen that, when the “covert channel generation code activation” interval is reached after the inactivation interval of 400 msec, a covert channel reception signal 30 is normally received in synchronization with the code activation intervals. However, it can be seen that, when the “covert channel generation code activation” interval is reached after an inactivation interval of 200 msec, a covert channel reception signal is not generated during each period marked as ‘A’ in FIG. 4, but is generated only after the period ‘A’. In summary, it can be seen that, in some cases, the generation of the covert channel signal needs to be halted for a certain period in order for the covert channel reception signal to be generated immediately in synchronization with the “covert channel generation code activation” interval 10. It can be seen that FIG. 4 shows the case where a covert channel signal is generated in synchronization with generation code activation only when the generation of a covert channel signal is halted for about 400 msec and then “covert channel generation code activation” occurs.

The case of FIG. 5 illustrates that, as in the case of FIG. 4, a covert channel signal is generated in synchronization with “covert channel generation code activation” only after a certain period has elapsed. The case of FIG. 5 illustrates that a covert channel signal is generated again only when the “covert channel generation code activation” occurs after a 3-second period has elapsed since a previous covert channel signal was generated once. As well, the case of FIG. 5 illustrates that the duration of a covert channel signal cannot be controlled. That is, even if the “covert channel generation code activation” occurs, the covert channel signal is generated only for a duration of 0.1 second or less, and the system autonomously stops signal generation. That is, this is the case where even the time at which the covert channel signal ends cannot be controlled. In summary, the case of FIG. 5 may be regarded as a system that is highly restrictive in terms of covert channel communication because neither the start time nor the end time of generation of the covert channel signal can be easily controlled.

As illustrated in these two cases, a covert channel signal is a forcibly generated signal from a component that is not a device used for communication, and thus there occasionally occurs the case where the covert channel signal cannot be easily controlled. In order to overcome these cases and perform covert channel communication, the modulation methods proposed in the present disclosure may be very useful. In particular, the variable time-gap modulation method according to the present disclosure is suitable for the two cases of FIGS. 4 and 5.

FIG. 6 is a diagram illustrating a transmission packet structure according to an embodiment of the present disclosure.

Referring to FIG. 6, the case where a transmission packet structure such as that shown in FIG. 6 is used will be described by way of example in order to explain a method for transferring actual data using the above-described modulation methods presented by the present disclosure.

A packet that is the minimum unit of data transfer is composed of a “header” indicating the start of the packet, a “payload” containing a message desired to be transferred, and “CRC” used to check errors in received data. Here, the header is divided into a Start Frame Delimiter (SFD) field and a Length field.

The Start Frame Delimiter (SFD) (composed of 3 bits) is a predefined fixed bit field, which may be used to indicate the start of a packet being transmitted. In the present example, the value of SFD is fixed to ‘101’.

The Length field may indicate the length of the payload in bytes. In the present example, the Length field may be fixed to 5 bits, and may have a value of 0x08.

The payload field may contain a message desired to be actually transferred.

The Cyclic Redundancy Check (CRC) field is intended to check whether errors are present in received data. In the present example, the CRC field is fixed to 8 bits and has a value of 0x4A.

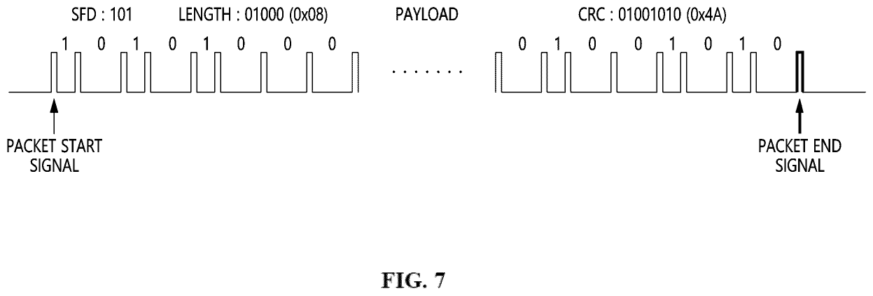

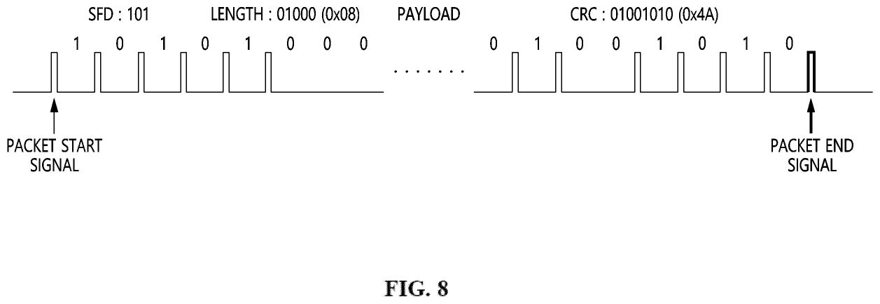

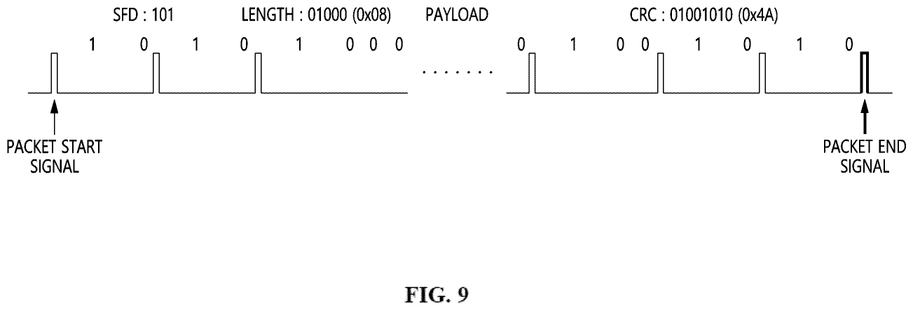

FIG. 7 is a diagram illustrating an example of packet transmission using separated time-gap modulation according to an embodiment of the present disclosure. FIG. 8 is a diagram illustrating an example of packet transmission using continuous time-gap modulation according to an embodiment of the present disclosure. FIG. 9 is a diagram illustrating an example of packet transmission using variable time-gap modulation according to an embodiment of the present disclosure.

When data is transferred using the above-described packet configuration, respective signal generation forms for three modulation methods presented by the present disclosure (i.e., separated time-gap modulation, continuous time-gap modulation, and variable time-gap modulation) may be represented by drawings, as illustrated in FIGS. 7, 8, and 9, respectively.

Also, a packet start signal may be identified by preventing a covert signal from being generated during a sufficient interval between packets.

As described above, as in the case of the example of data communication using a packet structure, it can be seen that the modulation methods presented in the present disclosure may efficiently transfer data through the covert channel.

Although the foregoing operation scenario is described as one example, the present disclosure is not limited to the illustrated example. By utilizing the modulation methods presented in the present disclosure, the execution of a function of transferring information through the covert channel may be enabled under various operation scenarios.

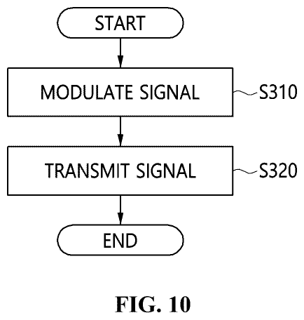

FIG. 10 is an operation flowchart illustrating a method for modulating communication signals for a wireless covert channel according to an embodiment of the present disclosure.

Referring to FIG. 10, the method for modulating communication signals for a wireless covert channel according to the embodiment of the present disclosure may modulate a signal at step S310.

That is, at step S310, a covert channel signal in which a time gap between signals is differently set in a communication signal may be generated, and then the communication signal may be modulated such that a bit value ‘1’ and a bit value ‘0’ are defined according to the time gap between the signals.

Here, at step S310, when the time gap between the signals is longer than a preset time gap, the bit value may be defined as the bit value ‘1’ (or ‘0’), whereas when the time gap is shorter than the preset time gap, the bit value may be defined as the bit value ‘0’ (or ‘1’).

Here, at step S310, whenever the bit value changes, the covert channel signal is generated, and thus the bit value may be defined as a different value during each time gap in which the covert channel signal is generated.

At step S310, the bit value may be defined such that a number of same bit values, equal in number to the integer value obtained by dividing the time gap by the preset time, are present during the time gap.

Here, at step S310, the bit value may be defined such that only one bit value ‘1’ (or ‘0’) is present between the signals, after which a bit value ‘0’ (or ‘1’) is not present or, alternatively, at least one bit value ‘0’ (or ‘1’) is present.

Here, at step S310, the bit value may be defined such that only one bit value ‘1’ (or ‘0’) is present during a preset first time between the signals, and a number of bit values ‘0’ (or ‘1’) equal in number to the integer value obtained by dividing the remaining time, which is obtained by subtracting the preset first time from the entire time gap between the signals, by a preset second time, are present between the signals.

Further, the method for modulating communication signals for a wireless covert channel according to the embodiment of the present disclosure may transmit the signal at step S320.

That is, at step S320, the communication signal modulated by generating the covert channel signal may be transmitted.

The apparatus and method for modulating communication signals for a wireless covert channel according to embodiments of the present disclosure may minimize the time required for signal generation to such an extent as to check signal generation or non-generation for a signal generated for channel communication, thus performing covert channel communication without difficulty even if only a minimum load is imposed on a covert communication system. Further, in the case of a system which cannot control the generation start time or duration of the signal generated for a covert channel, the present disclosure may effectively perform communication even in a system highly restrictive in terms of a covert channel by utilizing a method of transferring information only with a time gap between signals.

Consequently, the present disclosure may perform covert channel communication using only a signal having a minimum generation time, thus making it more difficult for a third party other than a designated receiver to detect signals in the covert channel and minimizing a system overload.

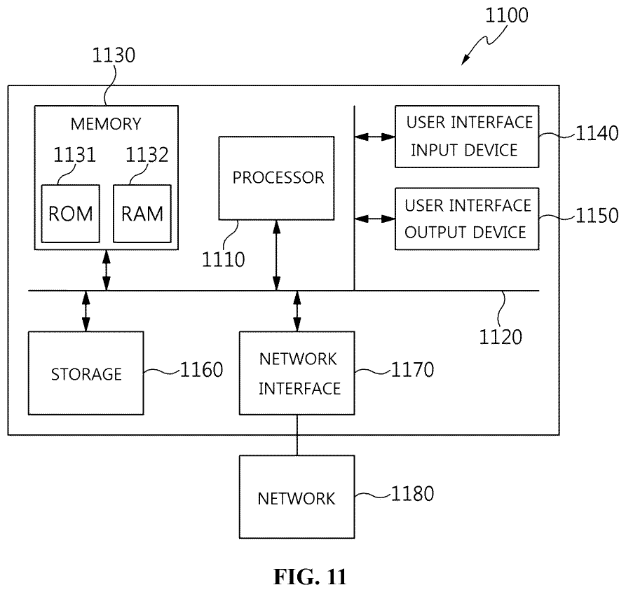

FIG. 11 is a diagram illustrating a computer system according to an embodiment of the present disclosure.

Referring to FIG. 11, an apparatus for modulating communication signals for a wireless covert channel according to an embodiment of the present disclosure may be implemented in a computer system 1100 such as a computer-readable storage medium. As illustrated in FIG. 11, the computer system 1100 may include one or more processors 1110, memory 1130, a user interface input device 1140, a user interface output device 1150, and storage 1160, which communicate with each other through a bus 1120. The computer system 1100 may further include a network interface 1170 connected to a network 1180. Each processor 1110 may be a Central Processing Unit (CPU) or a semiconductor device for executing processing instructions stored in the memory 1130 or the storage 1160. Each of the memory 1130 and the storage 1160 may be any of various types of volatile or nonvolatile storage media. For example, the memory 1130 may include Read-Only Memory (ROM) 1131 or Random Access Memory (RAM) 1132.

An apparatus for modulating communication signals for a wireless covert channel according to an embodiment of the present disclosure the present disclosure may include one or more processors 1110 and memory 1130 configured to store at least one program that is executed by the one or more processors 1110, wherein the at least one program is configured to modulate a communication signal such that a bit value ‘1’ and a bit value ‘0’ are defined according to a time gap between signals by generating a covert channel signal in which the time gap between the signals is differently set in the communication signal, and transmit the communication signal modulated by generating the covert channel signal.

Here, the at least one program may be configured to, when the time gap between the signals is longer than a preset time gap, define the bit value as the bit value ‘1’ (‘0’), whereas when the time gap is shorter than the preset time gap, define the bit value as the bit value ‘0’ (or ‘1’).

Here, the at least one program may be configured to define the bit value differently for each time gap in which the covert channel signal is generated by generating the covert channel signal whenever the bit value changes in the communication signal.

Here, the at least one program may be configured to define the bit value such that a number of identical bit values, equal in number to an integer value obtained by dividing the entire time gap by a preset time, are present during the time gap.

Here, the at least one program may be configured to define the bit value such that only one bit value ‘1’ (or ‘0’) is present between the signals, after which a bit value ‘0’ (or ‘1’) is not present or, alternatively, at least one bit value ‘0’ (or ‘1’) is present.

Here, the at least one program may be configured to define the bit value such that only one bit value ‘1’ (or ‘0’) is present during a preset first time between the signals and a number of bit values ‘0’ (or ‘1’) equal in number to an integer value obtained by dividing a remaining time, which is obtained by subtracting the preset first time from the entire time gap, by a preset second time, are present between the signals.

Further, a method for modulating communication signals for a wireless covert channel according to an embodiment of the present disclosure may be performed by an apparatus for modulating communication signals for a wireless covert channel, and may include the step of modulating a communication signal such that a bit value ‘1’ and a bit value ‘0’ are defined according to a time gap between signals by generating a covert channel signal in which the time gap between the signals is differently set in the communication signal, and the step of transmitting the communication signal modulated by generating the covert channel signal.

Here, the modulating step may include, when the time gap between the signals is longer than a preset time gap, defining the bit value as the bit value ‘1’ (or ‘0’), whereas when the time gap is shorter than the preset time gap, defining the bit value as the bit value ‘0’ (or ‘1’).

Here, the modulating step may include defining the bit value differently for each time gap in which the covert channel signal is generated by generating the covert channel signal whenever the bit value changes in the communication signal.

Here, the modulating step may further include defining the bit value such that a number of identical bit values, equal in number to an integer value obtained by dividing the entire time gap by a preset time, are present during the time gap.

Here, the modulating step may include defining the bit value such that only one bit value ‘1’ (or ‘0’) is present between the signals, after which a bit value ‘0’ (or ‘1’) is not present or, alternatively, at least one bit value ‘0’ (or ‘1’) is present.

Here, the modulating step may further include defining the bit value such that only one bit value ‘1’ (or ‘0’) is present during a preset first time between the signals and a number of bit values ‘0’ (or ‘1’) equal in number to an integer value obtained by dividing a remaining time, which is obtained by subtracting the preset first time from the entire time gap, by a preset second time, are present between the signals.

The present disclosure may maximize concealment by which a covert channel cannot be easily detected and minimize a system load caused by the generation of signals for the covert channel by minimizing the generation time of signals for the covert channel.

Further, the present disclosure may effectively perform communication even in a system that is highly constrained from the aspect of a covert channel.

Furthermore, the present disclosure may perform covert channel communication using only signals having a minimum generation time, thus making it more difficult for a third party other than a designated receiver to detect signals in the covert channel.

As described above, in the apparatus and method for modulating communication signals for a wireless covert channel according to the present disclosure, the configurations and schemes in the above-described embodiments are not limitedly applied, and some or all of the above embodiments can be selectively combined and configured so that various modifications are possible.

What is claimed is:

1. An apparatus for modulating communication signals for a wireless covert channel, comprising:
one or more processors; and
a memory configured to store at least one program that is executed by the one or more processors,
wherein the at least one program is configured to:
modulate a communication signal such that a bit value ‘1’ and a bit value ‘0’ are defined according to a time gap between signals by generating a covert channel signal in which the time gap between the signals is differently set in the communication signal, and
transmit the communication signal modulated by generating the covert channel signal.

2. The apparatus of claim 1, wherein the at least one program is configured to, when the time gap between the signals is longer than a preset time gap, define the bit value as the bit value ‘1’ or ‘0’, whereas when the time gap is shorter than the preset time gap, define the bit value as the bit value ‘0’ or ‘1’.

3. The apparatus of claim 1, wherein the at least one program is configured to define the bit value differently for each time gap in which the covert channel signal is generated by generating the covert channel signal whenever the bit value changes in the communication signal.

4. The apparatus of claim 3, wherein the at least one program is configured to define the bit value such that a number of identical bit values, equal in number to an integer value obtained by dividing the entire time gap by a preset time, are present during the time gap.

5. The apparatus of claim 1, wherein the at least one program is configured to define the bit value such that only one bit value ‘1’ or ‘0’ is present between the signals, after which a bit value ‘0’ or ‘1’ is not present or, alternatively, at least one bit value ‘0’ or ‘1’ is present.

6. The apparatus of claim 5, wherein the at least one program is configured to define the bit value such that only one bit value ‘1’ or ‘0’ is present during a preset first time between the signals and a number of bit values ‘0’ or ‘1’ equal in number to an integer value obtained by dividing a remaining time, which is obtained by subtracting the preset first time from the entire time gap, by a preset second time, are present between the signals.

7. A method for modulating communication signals for a wireless covert channel, the method being performed by an apparatus for modulating communication signals for a wireless covert channel, the method comprising:
modulating a communication signal such that a bit value ‘1’ and a bit value ‘0’ are defined according to a time gap between signals by generating a covert channel signal in which the time gap between the signals is differently set in the communication signal; and
transmitting the communication signal modulated by generating the covert channel signal.

8. The method of claim 7, wherein the modulating comprises:
when the time gap between the signals is longer than a preset time gap, defining the bit value as the bit value ‘1’ or ‘0’, whereas when the time gap is shorter than the preset time gap, defining the bit value as the bit value ‘0’ or ‘1’.

9. The method of claim 7, wherein the modulating comprises:
defining the bit value differently for each time gap in which the covert channel signal is generated by generating the covert channel signal whenever the bit value changes in the communication signal.

10. The method of claim 9, wherein the modulating further comprises:
defining the bit value such that a number of identical bit values, equal in number to an integer value obtained by dividing the entire time gap by a preset time, are present during the time gap.

11. The method of claim 7, wherein the modulating comprises:
defining the bit value such that only one bit value ‘1’ or ‘0’ is present between the signals, after which a bit value ‘0’ or ‘1’ is not present or, alternatively, at least one bit value ‘0’ or ‘1’ is present.

12. The method of claim 11, wherein the modulating further comprises:
defining the bit value such that only one bit value ‘1’ or ‘0’ is present during a preset first time between the signals and a number of bit values ‘0’ or ‘1’ equal in number to an integer value obtained by dividing a remaining time, which is obtained by subtracting the preset first time from the entire time gap, by a preset second time, are present between the signals.
